(19) United States
(12) Patent Application Publication
(10) Pub. No.: US 2011/0275003 A1
(43) Pub. Date: Nov. 10, 2011

(54) FUEL CELL

(76) Inventors: Mitsuru Udatsu, Kawasaki-shi (JP); Hirofumi Kan, Kawasaki-shi (JP); Asako Satoh, Yokohama-shi (JP); Mitsuru Furuichi, Chigasaki-shi (JP); Jun Momma, Yokohama-shi (JP)

(21) Appl. No.: 13/185,971

(22) Filed: Jul. 19, 2011

Related U.S. Application Data
(63) Continuation of application No. PCT/JP2010/000322, filed on Jan. 21, 2010.

(30) Foreign Application Priority Data
Jan. 23, 2009 (JP) P2009-012836
Jun. 29, 2009 (JP) P2009-153778

(51) Int. Cl. H01M 8/10

(52) U.S. Cl. 429/479

(57) ABSTRACT

A fuel cell includes: an anode catalyst layer containing an anode catalyst and a proton-conductive electrolyte; a cathode catalyst layer containing a cathode catalyst and a proton-conductive electrolyte; a proton-conductive electrolyte membrane interposed between the anode catalyst layer and the cathode catalyst layer; and a mechanism supplying a fuel to the anode catalyst layer, wherein a porosity of the anode catalyst layer as measured by a mercury intrusion porosimeter is 0 to 30%.

### CROSS-REFERENCE TO RELATED APPLICATIONS

This application is a continuation of prior International Application No. PCT/JP2010/000322, filed on Jan. 21, 2010, which is based upon and claims the benefit of priorities from Japanese Patent Application No. 2009-012836, filed on Jan. 23, 2009 and Japanese Patent application No. 2009-153778, filed on Jun. 29, 2009; the entire contents of all of which are incorporated herein by reference.

### FIELD

Embodiments described herein relates generally to a fuel cell.

### BACKGROUND

In recent years, electronic devices such as personal computers and mobile phones have become more and more compact with the development of semiconductor technology, and an attempt has been made to use fuel cells as power sources of these electronic devices. The fuel cell is a system capable of generating electricity only by being supplied with a fuel and an oxidant. In particular, a DMFC (Direct Methanol Fuel Cell is considered as a promising power source for small devices because it uses high energy density methanol as its fuel, a current can be taken out directly from methanol on its electrode catalyst, and it requires no reformer.

As a method of supplying the fuel in the DMFC, there have been known a gas supply type which sends a liquid fuel, after vaporizing it, into the fuel cell by a blower or the like, a liquid supply type which sends a liquid fuel with a 50 mol % concentration or lower as it is into the fuel cell by a pump or the like, an internal vaporization type which vaporizes a liquid fuel with a 50 mol % concentration or higher inside the fuel cell, and so on.

The internal vaporization type DMFC includes a layer holding the liquid fuel and a gas-liquid separation membrane for diffusing a vaporized component of the held liquid fuel, and is structured such that the vaporized liquid fuel is supplied to an anode catalyst layer via the gas-liquid separation membrane.

In the anode catalyst layer, vaporized methanol and water react with each other, resulting in the production of carbon dioxide and hydrogen ions (protons) as shown in Expression (1).

CH₃OH+H₂O→CO₂+6H⁺+6e⁻ (1)

In a cathode catalyst layer, reaction accompanied by the production of water as shown in Expression (2) progresses.

(3/2)O₂+6H⁺+6e⁻→3H₂O (2)

Further, in the cathode catalyst layer, methanol diffused from the anode side to the cathode side is directly oxidized, so that water is produced. This water is supplied to the anode side by its self-diffusion and is used as water necessary for the reaction of Expression (1) in the anode catalyst layer.

In the conventional DMFC, the anode catalyst layer is structured to contain an anode catalyst and a proton-conductive electrolyte and have many pores in order to increase an interface where the reaction occurs (three-phase interface of the catalyst, the fuel, and the electrolyte).

In the fuel cell having such a structure, however, when a high-concentration methanol aqueous solution or pure methanol is used as the fuel, shortage of water necessary for the reaction of Expression (1) is likely to occur because an amount of water contained in the fuel is small. Consequently, the high-concentration methanol reaches the anode catalyst as it is, which has given rise to a problem that not only a high output cannot be obtained but also the anode catalyst and the electrolyte deteriorate, resulting in the gradual deterioration in an electricity generation characteristic. Further, during operation, the electrolyte in the anode catalyst layer absorbs the fuel and the generated water to swell, whereas during non-operation, the contained fuel and water are volatilized/dried, so that the electrolyte shrinks, which has given rise to a problem that repeating the operation/non-operation cycle in intermittent operation causes physical deterioration such as interfacial peeling between the anode catalyst layer and the electrolyte membrane.

### BRIEF DESCRIPTION OF THE DRAWINGS

FIG. 1 is a vertical sectional view showing the structure of one embodiment of a fuel cell according to an embodiment.

FIG. 2 is a graph showing changes of outputs with time in fuel cells of Examples 1, 2 and Comparative Examples 1, 2.

FIG. 3 is a graph plotting porosities of anode catalyst layers and outputs after 100 hours from the start of electricity generation in the fuel cells of Examples 1, 2 and Comparative Examples 1, 2, with respect to content ratios of Nafion.

FIG. 4 is a graph plotting ratios between metal specific surface areas of anode catalysts before and after the inclusion and the outputs after 100 hours from the start of the electricity generation in the fuel cells of Examples 1, 2 and Comparative Examples 1, 2, with respect to the content ratios of Nafion.

### DETAILED DESCRIPTION

A fuel cell according to an embodiment includes: an anode catalyst layer containing an anode catalyst and a proton-conductive electrolyte; a cathode catalyst layer containing a cathode catalyst and a proton-conductive electrolyte; a proton-conductive electrolyte membrane interposed between the anode catalyst layer and the cathode catalyst layer; and a mechanism supplying a fuel to the anode catalyst layer, wherein a porosity of the anode catalyst layer as measured by a mercury intrusion porosimeter is 0 to 30%.

The fuel cell according to the embodiment, the anode catalyst is covered by the proton-conductive electrolyte and the porosity of the anode catalyst layer is reduced to 0 to 30%, which enables a fuel cell using a high-concentration fuel to have an enhanced output characteristic and improved long-term output stability and durability.

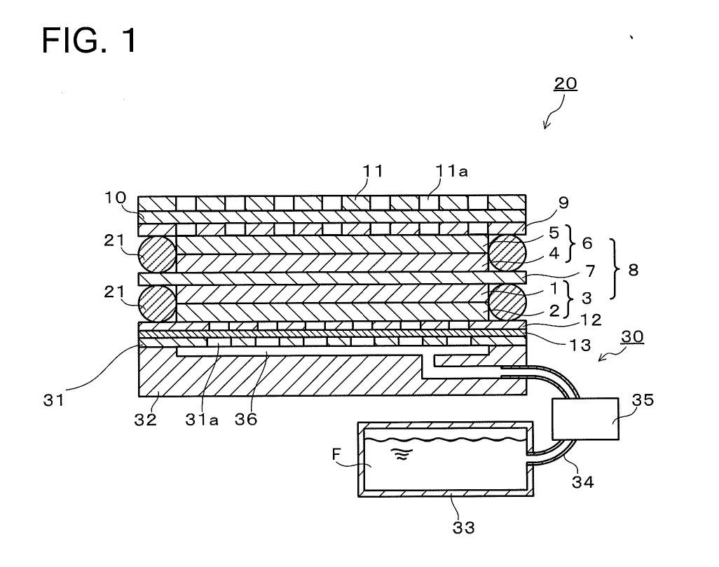

Hereinafter, an embodiment will be described with reference to the drawings. FIG. 1 is a cross-sectional view showing the structure of one embodiment of a fuel cell according to the present invention.

As shown in FIG. 1, the fuel cell 20 of the embodiment includes a MEA (Membrane Electrode Assembly) 8 including: an anode 3 having an anode catalyst layer 1 and an anode gas diffusion layer 2; a cathode 6 having a cathode catalyst layer 4 and a cathode gas diffusion layer 5; and a proton-conductive electrolyte membrane 7 interposed between the anode catalyst layer 1 and the cathode catalyst layer 4. It further includes, on an outer side of the cathode 6 of the MEA 8, a cathode conductive layer 9, a moisture retention layer 10, and a surface cover layer 11 stacked on the moisture retention layer 10 and having a plurality of air inlet holes 11a. It further includes, on an outer side of the anode 3 of the MEA 8, an anode conductive layer 12, a gas-liquid separation membrane 13, and a fuel supply mechanism 30 supplying a liquid fuel F to the anode 3 (anode catalyst layer 1).

The anode catalyst layer 1 and the cathode catalyst layer 4 each contain a catalyst and a proton-conductive electrolyte. The electrolyte has methanol permeability as well as proton conductivity. Possible examples of the anode catalyst contained in the anode catalyst layer 1 and the cathode catalyst contained in the cathode catalyst layer 4 are element metals such as Pt, Ru, Rh, Ir, Os, and Pd which are platinum-group elements, alloys containing any of these platinum-group elements, and the like. Concretely, an alloy such as Pt—Ru or Pt—Mo having high resistance against methanol and carbon monoxide is preferably used as the anode catalyst, and a metal catalyst such as Pt, a Pt—Ni alloy, or a Pt—Co alloy is preferably used as the cathode catalyst, but the anode and cathode catalysts are not limited to these. Alternatively, a supported catalyst in which particulates of any of these catalysts are carried by a conductive carrier may be used. As the conductive carrier, granular carbon or fibrous carbon such as activated carbon or graphite is used, but the conductive carrier is not limited to any of these.

Possible examples of the electrolytes with proton conductivity and methanol permeability which are contained, besides these catalysts, in the anode catalyst layer 1 and the cathode catalyst layer 4 are: organic materials such as fluorine-based resin such as a perfluorocarbon polymer having a sulfonic acid group and hydrocarbon-based resin having a sulfonic acid group; or inorganic materials such as tungstic acid and phosphotungstic acid. Concrete examples are Nafion (product name; manufactured by Du Pont), Flemion (product name; manufactured by Asahi Glass Co., Ltd.), and Aciplex (product name; manufactured by Asahi Glass Co., Ltd.). It should be noted that the electrolytes having proton conductivity and methanol permeability are not limited to these, and for example, usable are electrolytes capable of transporting hydrogen ions (protons) and methanol, such as a copolymer of a trifluorostyrene derivative, a polybenzimidazole film impregnated with phosphoric acid, aromatic polyetherketone sulfonic acid, or aliphatic hydrocarbon-based resin.

In the embodiment, a porosity of the anode catalyst layer 1 as measured by a mercury intrusion porosimeter is 0 to 30%. With the porosity of the anode catalyst layer 1 being 30% or less, even if a high-concentration methanol fuel is used, methanol is diluted by water in the proton-conductive electrolyte and thus methanol having a concentration optimum for the anode reaction is supplied to the anode catalyst. Therefore, a high output can be obtained. With the porosity being over 30%, the high-concentration methanol fuel passes through pore portions of the anode catalyst layer 1 to directly reach the anode catalyst (front surface thereof) without permeating through a layer of the proton-conductive electrolyte, and therefore, a high output cannot be obtained. The lower the porosity of the anode catalyst layer 1, the better, and the porosity is most preferably 0% meaning that substantially no pore exists. A value of a porosity of the cathode catalyst layer 4 (as measured by the mercury intrusion porosimeter) is also preferably 30% or less (including 0%), but is not particularly limited.

The mercury intrusion porosimeter is an instrument to measure a volume (distribution) of pores, and the measurement of the porosity of the anode catalyst layer 1 by this instrument can be conducted in the following manner. Specifically, the MEA 8 taken out from the disassembled fuel cell 20 is immersed in water for several hours (for example, five hours), only the anode catalyst layer 1 is thereafter peeled off, and the peeled anode catalyst layer 1 is dried for 24 hours in a vacuum at room temperature. The porosity of the dried sample is measured by the mercury intrusion porosimeter (name of the instrument: Pascal 240; manufactured by Thermo Fischer Scientific K.K.).

In order to change the porosity of the anode catalyst layer 1 (and the cathode catalyst layer 4 when necessary), adoptable is a method of adjusting a composition ratio of the anode catalyst and the proton-conductive electrolyte which are contained in the anode catalyst layer 1. By adjusting the content ratio of the proton-conductive electrolyte in the anode catalyst layer 1 to over 40% by weight and not greater than 80% by weight, it is possible to adjust the porosity of the anode catalyst layer 1 to 0 to 30%.

Further, in the fuel cell 20 of the embodiment, a ratio of a metal specific surface area of the anode catalyst (measured by a CO pulse adsorption method. The same applies hereinafter.) in the anode catalyst layer 1 having the 0 to 30% porosity to a metal specific surface area of the anode catalyst itself before it is included in the anode catalyst layer 1 is preferably 0 to 20%. This means that a most part of a surface of the anode catalyst metal in the anode catalyst layer 1 is covered by the proton-conductive electrolyte and an exposed surface area of the anode catalyst metal is 20% or less (including 0%) of the total surface area. The CO pulse absorption method is a method in which a fixed amount of CO (gas) is intermittently injected to metal particles existing on the surface and a difference between an amount of steadily eluted CO and a CO amount measured at the time of the first adsorption is measured as a Co adsorption amount. By this method, an exposed surface area per unit mass of the metal catalyst can be found as the specific surface area.

When the ratio of the metal specific surface area of the anode catalyst in the anode catalyst layer 1 to the metal specific surface area of the anode catalyst before it is included in the anode catalyst layer 1 (hereinafter, referred to as a ratio between the metal specific surface areas of the anode catalyst before and after the inclusion) is 20% or less (including 0%), a most part (80% or more) of the surface of the anode catalyst is covered by the proton-conductive electrolyte, and therefore, even if a high-concentration methanol fuel is used, methanol is diluted by water in the electrolyte and methanol having a concentration optimum for the anode reaction is supplied to the anode catalyst. Therefore, a high output can be obtained. When the ratio between the metal specific surface areas of the anode catalyst before and after the inclusion is over 20%, a large amount of the high-concentration methanol fuel directly reaches the surface of the anode catalyst metal without permeating through the layer of the proton-conductive electrolyte, and thus a high output cannot be obtained.

In the embodiment, most preferably, the ratio between the metal specific surface areas of the anode catalyst before and after the inclusion is 0% and the surface of the anode catalyst is completely covered by the electrolyte. In the cathode catalyst layer 4, it is also preferable that a ratio between metal specific surface areas of the cathode catalyst before and after the inclusion is 20% or less (including 0%), but this is not restrictive.

The metal specific surface area of the anode catalyst contained in the anode catalyst layer 1 can be measured as follows. First, the MEA 8 taken out from the disassembled fuel cell is immersed in water for several hours (for example, five hours), only the anode catalyst layer 1 is thereafter peeled off, and the separated anode catalyst layer 1 is dried for 24 hours in a vacuum at room temperature. The obtained anode catalyst layer 1 is slightly ground in a mortar, and the resultant powder (for example, powder with about 1 mm grain size) is filled in a gauge tube of a CO gas adsorption measuring instrument (name of the instrument: BEL-CAT B; manufactured by BEL Japan Inc.). Then, a CO pulse adsorption amount is measured at a predetermined temperature (for example, 50° C.) and the metal specific surface area of the anode catalyst is found. Further, as for the measurement of the metal specific surface area of the anode catalyst before it is included in the anode catalyst layer, the powder of the anode catalyst is filled as it is in the gauge tube of the CO gas adsorption measuring instrument, a CO pulse adsorption amount is measured at a predetermined temperature (for example, 50° C.), and the metal specific surface area is found.

In order to change the ratio between the metal specific surface areas of the anode catalyst before and after the inclusion in the anode catalyst layer 1 (and the cathode catalyst layer 4 when necessary), adoptable is a method of adjusting a composition ratio of the anode catalyst and the proton-conductive electrolyte which are contained in the anode catalyst layer 1. By adjusting a content ratio of the proton-conductive electrolyte in the anode catalyst layer 1 to over 40% by weight and not greater than 80% by weight, it is possible to adjust the ratio between the metal specific surface areas of the anode catalyst before and after the inclusion to 20% or less.

Further, in the embodiment, the anode catalyst layer 1 preferably contains a reinforcing material. Examples of the reinforcing material contained in the anode catalyst layer 1 are: a granular substance or a fibrous substance made of carbon, an inorganic material, macromolecules, metal, or the like; a porous support having a structure in which communication holes are regularly arranged; and the like. The combination of these may be used. These reinforcing materials can also be used as a carrier of the aforesaid catalyst metal particles. A content ratio of the reinforcing material is preferably 5 to 30% by weight to the whole anode catalyst layer 1, but is not particularly limited unless it has a significant influence on electricity generation performance.

More concretely, as the fibrous substance, usable is fibrous carbon with a 100 nm to 10 cm length (fiber length) and a 0.5 nm to 1 mm diameter (average fiber diameter), preferably with a 100 nm to 500 μm length and a 0.5 nm to 100 μm diameter such as carbon nanotube or carbon nanofiber. Further, as the granular substance, usable is a particle made of macromolecules, metal, an inorganic material, or the like with a 10 nm to 10 mm diameter (average particle size), preferably, with a 10 nm to 100 μm diameter (average particle size). Further, as the support, usable is a porous support made of polyimide, carbon, or the like and having regularly arranged communication holes. When the porous support is used, the catalyst and the proton-conductive electrolyte are preferably filled/contained in the communication holes (10 nm to 1 mm diameter, preferably, 10 nm to 100 μm diameter) of the support. This structure can suppress the deterioration of the function as the catalyst layer (anode catalyst layer 1).

Thus making the reinforcing material contained in the anode catalyst layer 1 can reinforce and stabilize the structure of the catalyst layer, which makes it possible to prevent the deterioration and breakage of the anode catalyst layer 1 ascribable to the repeated operation/non-operation cycle, enhance durability, and improve long-term stability of the output.

In the embodiment, the anode gas diffusion layer 2 is stacked on thus-structured anode catalyst layer 1. Further, the cathode gas diffusion layer 5 is stacked on the cathode catalyst layer 4. The anode gas diffusion layer 2 plays a role of uniformly supplying the fuel to the anode catalyst layer 1 and also plays a role as a current collector of the anode catalyst layer 1. The cathode gas diffusion layer 5 plays a role of uniformly supplying the air as an oxidant to the cathode catalyst layer 4 and also plays a role as a current collector of the cathode catalyst layer 4. These anode gas diffusion layer 2 and cathode gas diffusion layer 5 are each made of, for example, a porous carbonaceous material such as carbon paper, carbon cloth, or carbon silk, a porous material or mesh made of a metal material such as titanium, a titanium alloy, stainless steel, gold, or the like.

Further, the electrolyte membrane 7 having proton conductivity is interposed between the anode catalyst layer 1 and the cathode catalyst layer 4. The proton-conductive electrolyte contained in the electrolyte membrane 7 also has methanol permeability. Possible examples of a material forming the electrolyte membrane 7 are: organic materials such as fluorine-based resin (perfluorocarbon polymer) having a sulfonic acid group such as Nafion and Flemion, hydrocarbon-based resin having a sulfonic acid group, or the like; or inorganic materials such as tungstic acid and phosphotungstic acid. It should be noted that the proton-conductive electrolyte membrane 7 is not limited to these.

Further, the anode conductive layer 12 is stacked on the outer side of the anode gas diffusion layer 2 and the cathode conductive layer 9 is stacked on the outer side of the cathode gas diffusion layer 5. Examples of a material of the anode conductive layer 12 and the cathode conductive layer 9 are: a porous layer (for example, mesh), a foil, or a thin film made of a conductive metal material excellent in electric characteristic and chemical stability such as Au and Ni; a composite material in which highly-conductive metal such as gold covers a conductive metal material such as stainless steel (SUS).

A sealing member 21 having, for example, an O-shaped cross section and a rectangular frame shape in a plane view is provided between the proton-conductive electrolyte membrane 7 and the anode conductive layer 12 so as to surround the anode catalyst layer 1 and the anode gas diffusion layer 2. Further, a sealing member 21 having the same shape is also provided between the proton-conductive electrolyte membrane 7 and the cathode conductive layer 9 so as to surround the cathode catalyst layer 4 and the cathode gas diffusion layer 5. These sealing members 21 prevent the leakage of the fuel and the leakage of the oxidant from the MEA 8 and are each made of an elastic material such as rubber, for instance. Incidentally, FIG. 1 shows the fuel cell including the cathode conductive layer 9 but the cathode gas diffusion layer 5 may function as the conductive layer without the cathode conductive layer 9 being provided.

The moisture retention layer 10 is stacked on the cathode conductive layer 9. The moisture retention layer 10 contains part of water generated in the cathode catalyst layer 4 and has functions of suppressing the transpiration of water and diffusing part of the generated water to the anode side. It also has a function of uniformly guiding the air as the oxidant to the cathode gas diffusion layer 5 and promoting the uniform diffusion of the oxidant (air) to the cathode catalyst layer 4. As the moisture retention layer 10, a porous polyethylene film or the like is usable, for instance.

On the moisture retention layer 10, there is disposed the surface cover layer 11 having the plural air inlet holes 11a for the intake of the air as the oxidant. The surface cover layer 11 also plays a role of pressing the MEA 8 and the moisture retention layer 10 to enhance adhesiveness. For example, it can be made of metal such as SUS304 but is not limited to this. By changing the number, size, or the like of the air inlet holes 11a, it is possible to adjust an intake amount of the air in the surface cover layer 11.

The gas-liquid separation membrane 13 is disposed on the outer side (on the fuel supply mechanism 30 side) of the anode conductive layer 12. The gas-liquid separation membrane 13 separates a vaporized component of the liquid fuel F from the liquid fuel and allowing only the vaporized component to pass therethrough to the anode 3 side. The gas-liquid separation membrane 13 is made of a material that is inactive and does not melt in the fuel (for example, methanol). Concretely, it is made of a material such as a silicone rubber thin film, a low-density polyethylene (LDPE) thin film, a polyvinyl chloride thin film (PVC), a polyethylene terephthalate (PET) thin film, or a fluorine resin (for example, polytetrafluoroethylene (PTFE), tetrafluoroethylene perfluoroalkyl vinyl ether copolymer (PFA), or the like) micro-porous film. The gas-liquid separation membrane 13 is structured so as to prevent the fuel and so on from leaking from its peripheral edge.

A resin frame (not shown) may be provided between the gas-liquid separation membrane 13 and the anode conductive layer 12. Space surrounded by the frame functions as a vaporized fuel storage chamber (so-called vapor pool) temporarily storing the vaporized component of the fuel diffused through the gas-liquid separation membrane 13 and also functions as a reinforcing plate bringing the MEA 8 and the anode conductive layer 12 into close contact. A permeated methanol amount reducing effect of the vaporized fuel storage chamber and the gas-liquid separation membrane 13 prevents a large amount of the vaporized fuel from flowing into the MEA 8 (anode catalyst layer 1) at a time and suppresses the occurrence of fuel crossover. The frame is made of, for example, engineering plastic having high chemical resistance such as polyetheretherketone (PEEK; manufactured by Victrex plc.)

The fuel supply mechanism 30 is disposed on the outer side of the gas-liquid separation membrane 13. The fuel supply mechanism 30 includes: a fuel distribution layer 31 having a plurality of openings 31a provided to face openings of the anode conductive layer 12; a fuel supply part main body 32 supplying the liquid fuel F to the fuel distribution layer 31; a fuel storage part 33, a channel 34, and a pump 35 disposed at the middle of the channel 34.

The liquid fuel F appropriate for the MEA 8 is stored in the fuel storage part 33. As the liquid fuel F, usable is an aqueous solution or a non-aqueous solution of one substance or more selected from a group consisting of alcohol, carboxylic acid, and aldehyde. Concretely, used is a methanol fuel such as a methanol aqueous solution or pure methanol, an ethanol fuel such as an ethanol aqueous solution or pure ethanol, a propanol fuel such as a propanol aqueous solution or pure propanol, a glycol fuel such as a glycol aqueous solution or pure glycol, or a liquid fuel of dimethylether, formic acid, or other material. In any case, the liquid fuel appropriate for the fuel cell is stored. Among them, methanol has a carbon number of 1, produces carbon dioxide at the time of its reaction, is capable of electricity generation reaction at low temperature, and can be relatively easily manufactured from industrial waste. Therefore, it is preferable to use a methanol aqueous solution or pure methanol as the liquid fuel F. Further, one with a 50 mol % concentration or higher is suitably used but it is not restrictive.

The fuel supply part main body 32 includes a fuel supply part 36 which is an indented portion for dispersing the liquid fuel in order to uniformly supply the supplied liquid fuel F to the fuel distribution layer 31. The fuel supply part 36 is connected to the fuel storage part 33 via the channel 34 formed by a pipe or the like. The liquid fuel F is led from the fuel storage part 33 into the fuel supply part 36 via the channel 34, and the led liquid fuel F and/or the vaporized component of the liquid fuel F is (are) supplied to the gas-liquid separation membrane 13 via the fuel distribution layer 31. Then, only the vaporized component is supplied to the MEA 8.

The channel 34 is not limited to a pipe independent of the fuel supply part 36 and the fuel storage part 33. For example, when the fuel supply part 36 and the fuel storage part 33 are stacked to be integrated, the channel may be a channel of the liquid fuel F connecting them. That is, the fuel supply part 36 only needs to communicate with the fuel storage part 33 via the channel 34.

The pump 35 is disposed at part of the channel 34, and the liquid fuel F stored in the fuel storage part 33 is forcibly sent to the fuel supply part 36. Instead of the pump 35 disposed at the middle of the channel 34, the gravity may be used to drop and send the liquid fuel F stored in the fuel storage part 33 to the fuel supply part 36. Alternatively, with a porous material or the like being filled in the channel 34, the liquid fuel F may be sent to the fuel supply part 36 by capillary action.

The pump 35 functions as a supply pump simply sending the liquid fuel F from the fuel storage part 33 to the fuel supply part 36 and does not have a function as a circulating pump circulating an excessive part of the liquid fuel F supplied to the MEA 8. The fuel cell 20 having such a pump 35 is different in structure from a conventional active type since the fuel is not circulated therein. Further, it is different in structure from a pure passive type such as a conventional internal vaporization type, and falls under the category of what is called a semi-passive type. Incidentally, the kind of the pump 35 functioning as a fuel supplier is not particularly limited, but the use of a rotary vane pump, an electroosmotic flow pump, a diaphragm pump, a squeeze pump, or the like is preferable, considering that they are capable of sending a small amount of the liquid fuel F with good controllability and can be compact and light-weighted. The rotary vane pump sends the liquid by rotating vanes by a motor. The electroosmotic flow pump uses a sintered porous material such as silica generating an electroosmotic flow phenomenon. The diaphragm pump sends the liquid by driving a diaphragm by an electromagnet or piezoelectric ceramics. The squeeze pump presses part of a flexible fuel channel to send the fuel while squeezing it. Among them, in view of driving power, size, and so on, the use of the electroosmotic flow pump or the diaphragm pump having piezoelectric ceramics is more preferable. This pump 35 is electrically connected to a controller (not shown), and the controller controls a supply amount of the liquid fuel F supplied to the fuel supply part 36.

The fuel distribution layer 31 is a flat plate having the plural openings 31a and is made of a material not allowing the permeation of the liquid fuel F and its vaporized component. Concretely, the fuel distribution layer 31 is made of polyethylene terephthalate (PET) resin, polyethylene naphthalate (PEN) resin, polyimide resin, or the like and is interposed between the gas-liquid separation membrane 13 and the fuel supply part main body 32. The liquid fuel F led into the fuel supply part main body 32 is supplied to the whole surface of the anode 3 through the plural openings 31a of the fuel distribution layer 31. Thus, the fuel distribution layer 31 can make the fuel supply amount supplied to the anode 3 uniform.

Next, the operation of the fuel cell 20 shown in the embodiment will be described. The liquid fuel F supplied from the fuel storage part 33 to the fuel supply part 36 via the channel 34 passes through the liquid distribution layer 31 in the state of the liquid fuel or in a state where the liquid fuel and a vaporized fuel resulting from the vaporization of the liquid fuel co-exist, and thereafter passes through the gas-liquid separation membrane 13, and only the vaporized component of the liquid fuel F is supplied to the anode gas diffusion layer 2. The fuel supplied to the anode gas diffusion layer 2 diffuses in the anode gas diffusion layer 2 to be supplied to the anode catalyst layer 1. When a methanol fuel is used as the liquid fuel F, an internal reforming reaction of methanol expressed by Expression (1) below occurs in the anode catalyst layer 1.

CH₃OH+H₂O→CO₂+6H⁺+6e (1)

When pure methanol is used as the methanol fuel, methanol is reformed by the internal reforming reaction, which is expressed by the above Expression (1), with water generated in the cathode catalyst layer 4 and water in the electrolyte membrane 7, or is reformed by a different reaction mechanism not requiring water.

Electrons (e⁻) produced by this reaction are led to the outside via the current collector and after working as so-called electricity to operate an electronic device or the like, are led to the cathode 6. Further, protons (H⁺) produced by the internal reforming reaction of Expression (1) are led to the cathode 6 via the electrolyte membrane 7. The cathode 6 is supplied with the air as the oxidant. The electrons (e) and protons (H⁺) reaching the cathode 6 react with oxygen in the air in the cathode catalyst layer 4 as is expressed by the following Expression (2) and this reaction is accompanied by the production of water

(3/2)O₂+6e⁻+6H⁺→3H₂O (2)

In the fuel cell 20 of the embodiment, since the anode catalyst is covered by the proton-conductive electrolyte and the porosity of the anode catalyst layer 1 is reduced to 0 to 30%, it is possible to obtain a high output, long-term stability of the output, and so on. A conceivable reason for this is as follows. That is, since the porosity of the anode catalyst layer 1 is reduced, an amount of methanol as the fuel directly reaching the anode catalyst via the pores of the anode catalyst layer 1 is small. Then, the fuel permeates through the layer of the proton-conductive electrolyte to reach the anode catalyst and a two-phase interface of the anode catalyst and the proton-conductive electrolyte becomes an interface for the anode reaction expressed by Expression (1), and therefore, even when the high-concentration methanol fuel is used, methanol is diluted by water in the electrolyte, and as a result, methanol with a concentration optimum for the reaction is supplied to the anode catalyst. This is thought to be why the deterioration of the anode catalyst is prevented, a high output is possible, and the output is not likely to deteriorate.

The fuel cell of the above-described embodiment exhibits the effects when various kinds of liquid fuels are used, and the kind and concentration of the liquid fuel are not limited. Further, in the description of the above embodiment, the semi-passive type using the pump for supplying the fuel is taken as an example of the structure of the fuel cell main body, but the spirit of the embodiments is also applicable to a fuel cell of a pure passive type such as an internal vaporization type.

Next, based on examples and comparative examples, it will be described that the fuel cell according to the embodiments has excellent output characteristic and durability.

### Examples 1, 2, Comparative Examples 1, 2

Carbon black carrying anode catalyst particles (Pt:Ru=1:1), a Nafion solution DE2020 (name of product; manufactured by Du Pont) being a perfluoro sulfonic acid polymer solution as the proton-conductive electrolyte (resin) solution, water, and methoxypropanol were mixed, with a Nafion content ratio being varied, whereby anode catalyst slurries were prepared. The obtained anode catalyst slurries were each applied on one surface of porous carbon paper (30 mm×40 mm rectangle) which would serve as the anode gas diffusion layer, and thereafter were dried, whereby anode catalyst layers each with a 100 lam thickness were formed. By adjusting the content ratio of Nafion in each of the anode catalyst slurries, the content ratio of Nafion in the anode catalyst slurry was set to 60% by weight in Example 1 and to 80% by weight in Example 2. Further, the content ratio of Nafion in the anode catalyst layer was set to 40% by weight and 20% by weight in Comparative Example 1 and Comparative Example 2 respectively.

Further, carbon black carrying cathode catalyst particles (Pt), a Nafion solution DE2020 (name of product; manufactured by Du Pont) being a perfluoro sulfonic acid polymer solution as the proton-conductive electrolyte (resin) solution, water, and methoxypropanol were mixed, whereby cathode catalyst slurries were prepared. The obtained cathode catalyst slurries were each applied on one surface of porous carbon paper (same shape and same size as those of the porous carbon paper being the anode gas diffusion layer) which would serve as the cathode gas diffusion layer, and thereafter were dried, whereby cathode catalyst layers each with a 100 μm thickness were formed.

Next, as each of the proton-conductive electrolyte membranes, Nafion 112 (manufactured by Du Pont) being a solid electrolyte membrane containing a perfluoro sulfonic acid polymer with a 30 μm thickness and a 10 to 20% by weight water content was used, and this electrolyte membrane, the aforesaid anode (the anode gas diffusion layer and the anode catalyst layer) and cathode (the cathode gas diffusion layer and the cathode catalyst layer) were stacked, with the anode catalyst layer and the cathode catalyst layer being on the electrolyte membrane side, and thereafter hot pressing was applied, whereby each MEA was fabricated. The electrode area was set to 12 cm² both for the anode and the cathode.

Next, by using each of thus manufactured MEAs, the fuel cell shown in FIG. 1 was manufactured as follows. Specifically, the anode 3 side and the cathode 6 side of the MEA 8 were sandwiched by gold leaves having a plurality of open holes, whereby the anode conductive layer 12 and the cathode conductive layer 9 were formed. Then, between the electrolyte membrane 7 and the anode conductive layer 12 and between the electrolyte membrane 7 and the cathode conductive layer 9, rubber O-rings were interposed respectively for sealing. Further, on the outer side of the anode conductive layer 12, a frame made of polyetheretherketone (PEEK) was disposed, and on the outer side thereof (on the frame), the gas-liquid separation membrane 13 made of a porous polyethylene film, the fuel distribution layer 31 having the plural openings 31a, and the fuel supply part main body 32 were provided in sequence.

Further, as the moisture retention layer 10, a porous polyethylene film with a 500 μm thickness, 2 sec./100 cm³ air permeability (by a measuring method defined in JIS P-8117), and 400 g/(m²·24 h) water vapor permeability (by a measuring method defined in JIS L-1099 A-1) was used, and this was disposed on the cathode conductive layer 9. Further, on the moisture retention layer 10, a stainless steel plate (SUS304) with a 2 mm thickness having the air inlet holes 11a (the diameter 3 mm, the number of the holes 60) was disposed as the surface cover layer 11.

Further, by using a squeeze pump as the pump 35, part of the channel 34 was squeezed in one direction to cause a pressure, so that the liquid fuel F stored in the fuel storage part 33 was sent to the fuel supply part 32. Here, a control circuit controlling the number of rotation of the squeeze pump by a current passing through the fuel cell 20 was formed, and the number of rotation was controlled so that a fuel in an amount 1.2 times a fuel supply amount necessary for causing an electrochemical reaction in the fuel cell 20 (a 3.3 mg supply amount of methanol per one minute per 1 A current) was constantly supplied.

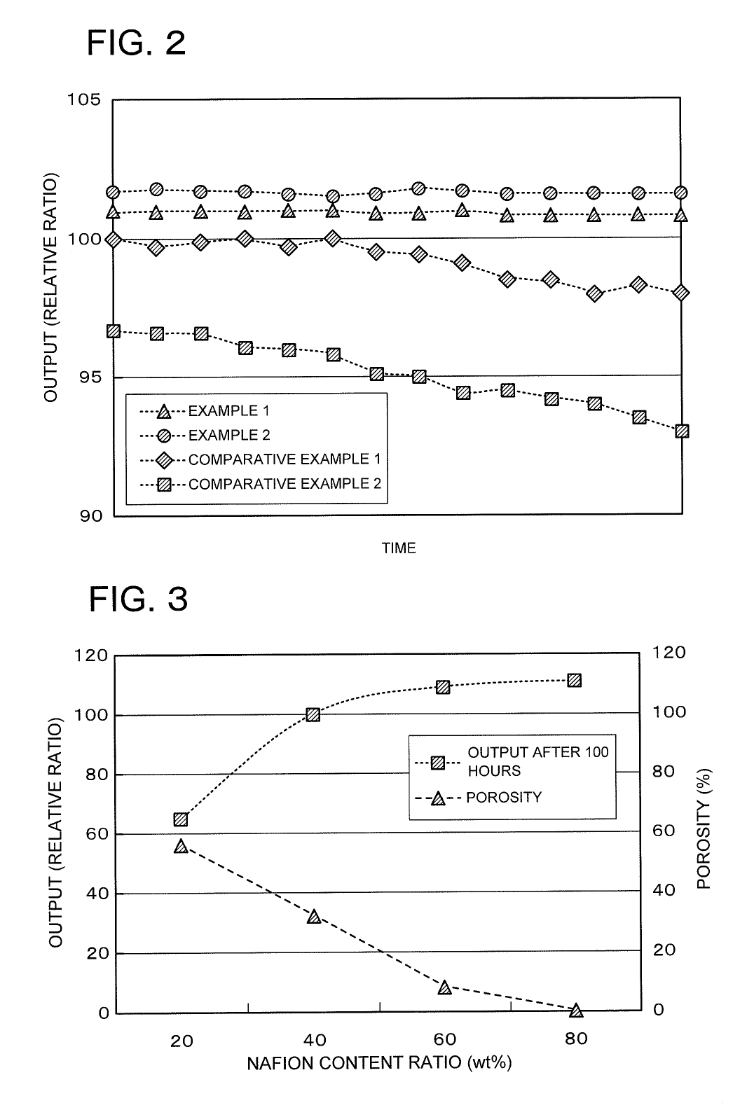

The fuel cells shown in FIG. 1 were thus manufactured and were caused to generate electricity by the supply of pure methanol into the fuel storage chambers 33. Then, changes of the outputs were measured in an environment with a 25° C. temperature and a 50% relative humidity. Thus measured changes of the outputs in accordance with the electricity generation time are shown in FIG. 2. Note that the outputs are each expressed as a relative ratio, with an initial output in Comparative Example 1 being defined as 100.

From the graphs in FIG. 2, the following was confirmed. Specifically, when the changes of the outputs in accordance with the electricity generation time are compared in the graphs in FIG. 2, in Example 1 and Example 2 where the Nafion content ratio in the anode catalyst layer 1 was set to 60% by weight and 80% by weight respectively, good initial characteristics were obtained, as compared with those of Comparative Example 1 and Comparative Example 2 where the Nafion content ratio was set to 40% by weight and 20% by weight respectively. Further, there occurred little deterioration in the outputs even after the long-time electricity generation, which leads to the finding that the deterioration in the output characteristics was suppressed.

Next, the fuel cells obtained in Examples 1, 2 and Comparative Example 1, 2 were disassembled, and the MEAs 8 were taken out. Then, the MEAs 8 taken out were immersed in water for several hours, only the anode catalyst layers 1 were thereafter peeled off from the MEAs 8, and the porosities of the anode catalyst layers 1 were measured by using the mercury intrusion porosimeter. Further, the metal specific surface area of the anode catalyst in the anode catalyst layer peeled off from each of the MEAs 8 after the several-hour immersion in water and the metal specific surface area of the anode catalyst before the inclusion were measured by the CO pulse adsorption method, and a ratio (%) of the former specific surface area to the latter specific surface area was calculated. Incidentally, the measurement by the CO pulse adsorption method was conducted at 50° C. by using a full-automatic catalyst gas adsorption measuring instrument BEL-CAT B (BEL Japan Inc.). These results are shown in Table 1.

TABLE 1

| | Example | Example | Comparative | Comparative |
|---|---|---|---|---|
| | 1 | 2 | Example 1 | Example 2 |
| Nafion Content | 60 | 80 | 40 | 20 |
| Ratio (wt %) | | | | |
| Porosity of Anode | 8 | 0 | 32 | 56 |
| Catalyst Layer (%) | | | | |
| Ratio Between | 13 | 0 | 21 | 42 |
| Metal Specific | | | | |
| Surface Areas | | | | |
| Before and After | | | | |
| Inclusion (%) | | | | |

It is seen from the results shown in Table 1 that in Example 1 (the Nafion content ratio is 60% by weight) and Example 2 (the Nafion content ratio is 80% by weigh) where the Nafion content ratio in the anode catalyst layer 1 is over 40% by weight, the porosity of the anode catalyst layer 1 is 30% or less and the ratio between the metal specific surface areas of the anode catalyst before and after the inclusion is 20% or less. On the other hand, it is seen that in Comparative Example 1 and Comparative Example 2 where the Nafion content ratio is 40% by weight and 20% by weight respectively, the porosity of the anode catalyst layer 1 is a value over 30% and the ratio between the metal specific surface areas of the anode catalyst before and after the inclusion is also a value over 20%.

From the above, it has been found out that setting the Nafion content ratio in the anode catalyst layer 1 to a value over 40% by weight makes it possible to set the porosity of the anode catalyst layer 1 to 30% or less (including 0%) and to set the ratio between the metal specific surface areas of the anode catalyst before and after the inclusion to 20% or less (including 0%), and the fuel cell thus structured is excellent in the initial output characteristic and long-term stability of the output.

Next, in order to study a correlation between the porosity of the anode catalyst layer 1 and the long-term stability of the output, the porosity of the anode catalyst layer and the output after 100 hours from the start of electricity generation, which were found for each of the fuel cells of Examples 1, 2 and Comparative Examples 1, 2, were plotted with respect to the Nafion content ratios in the anode catalyst layer 1. These graphs are shown in FIG. 3. Note that in FIG. 3, the outputs after 100 hours from the start of the electricity generation are each expressed as a relative ratio, with the output after 100 hours in Comparative Example 1 being defined as 100.

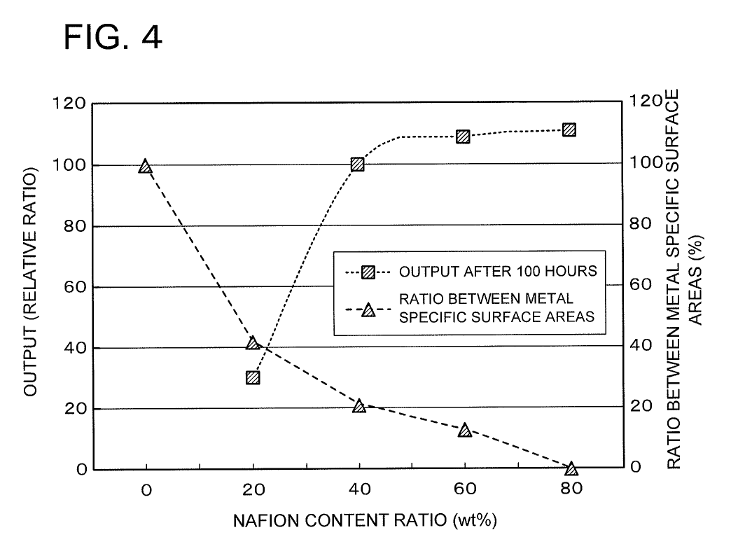

Further, in order to study a correlation between the ratio between the metal specific surface areas of the anode catalyst before and after the inclusion and the long-term stability of the output, the ratio between the metal specific surface areas of the anode catalyst before and after the inclusion and the output after 100 hours from the start of the electricity generation of the fuel cell, which were found for each of the fuel cells of Examples 1, 2 and Comparative Examples 1, 2, were plotted with respect to the Nafion content ratios in the anode catalyst layer 1. These graphs are shown in FIG. 4. Note that in FIG. 4, the outputs after 100 hours from the start of the electricity generation are each expressed as a relative ratio, with the output after 100 hours from the start of the electricity generation in Comparative Example 1 being defined as 100.

The following has been confirmed from the graphs in FIG. 3. Specifically, in the fuel cells of Example 1 and Example 2 where the content ratio of Nafion in the anode catalyst layer 1 was set to 60% by weight and 80% by weight respectively and the porosity of the anode catalyst layer 1 was set to 30% or less, the output characteristics were greatly improved as compared with those of the fuel cells of Comparative Example 1 and Comparative Example 2 where the porosity of the anode catalyst layer 1 was over 30%, and in particular in Example 2 where the porosity was 0%, the highest output was obtained.

Further, from the graphs in FIG. 4, the following has been confirmed. Specifically, in the fuel cells of Example 1 and Example 2 where the content ratio of Nafion in the anode catalyst layer 1 was set to 60% by weight and 80% by weight respectively and the ratio between the metal specific surface areas of the anode catalyst before and after the inclusion was set to 20% or less (including 0%), the output characteristics were improved as compared with those of the fuel cells of Comparative Example 1 and Comparative Example 2 where the ratio between the metal specific surface areas before and after the inclusion was over 20%, and in particular, in Example 2 where the ratio between the metal specific surface areas before and after the inclusion was 0%, the highest output was obtained.

### Example 3

Carbon fiber with a 5 μm average fiber length and a 100 nm average particle size was contained in the anode catalyst layer 1 so that its content ratio became 30% by weight. Except for this, a fuel cell was manufactured in the same manner as in Example 2.

When the output of this fuel cell was measured after the 100 operation/non-operation cycles each including five-hour operation and five-hour non-operation (intermittent operation) and its ratio (maintenance ratio) to the initial output was found, a 80% maintenance ratio to the initial output was exhibited as shown in Table 2. When, for comparison, the same 100 operation/non-operation cycles were also conducted for the fuel cell of Example 2 and an output maintenance ratio after the 100 cycles was measured, a 60% maintenance ratio to the initial output was exhibited.

TABLE 2

| | Example 2 | Example 3 |
|---|---|---|
| output maintenance ratio | 60% | 80% |
| after 100 cycles | | |

As described above, in the fuel cell of Example 3, the output maintenance ratio after the 100 cycles was greatly improved as compared with that of the fuel cell of Example 2. This measurement result has led to the understanding that in the fuel cell in which carbon fiber is contained in the anode catalyst layer 1, the deterioration of the anode catalyst layer 1 ascribable to the operation/non-operation cycle is suppressed and the initial output is well maintained even after the repeated cycles.

From the foregoing examples, it is seen that adjusting the porosity of the anode catalyst layer 1 to 30% or less (including 0%) and adjusting the ratio between the metal specific surface areas of the anode catalyst before and after the inclusion to 20% or less (including 0%) makes it possible to obtain a fuel cell having a high output and excellent in long-term stability of the output and durability. It is further seen that making the reinforcing material contained in the anode catalyst layer makes it possible to reinforce and stabilize the layer structure, prevent the deterioration and breakage of the anode catalyst layer ascribable to the operation/non-operation cycle, and further improve durability.

The above-described configuration is applicable to various kinds of fuel cells using a liquid fuel. Further, the concrete structure of the fuel cell, the supply state of the fuel, and so on are not particularly limited. When being implemented, the invention can be embodied by modifying the constituent elements within a range not departing from the technical idea of the invention. Further, various modifications can be made such as appropriately combining the plural constituent elements shown in the above embodiment and deleting some of the constituent elements from all the constituent elements shown in the embodiment. The embodiment described herein can be expanded or changed within a range of the technical idea of the present invention, and the expanded and changed embodiments are also included in the technical scope of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuel cell comprising:
an anode catalyst layer containing an anode catalyst and a proton-conductive electrolyte;
a cathode catalyst layer containing a cathode catalyst and a proton-conductive electrolyte;
a proton-conductive electrolyte membrane interposed between the anode catalyst layer and the cathode catalyst layer; and
a mechanism supplying a fuel to the anode catalyst layer,
wherein a porosity of the anode catalyst layer as measured by a mercury intrusion porosimeter is 0 to 30%.

2. The fuel cell according to claim 1,
wherein a ratio of a metal specific surface area of the anode catalyst contained in the anode catalyst layer (measured by a CO pulse adsorption method) to a metal specific surface area of the anode catalyst that is not yet included in the anode catalyst layer (measured by the CO pulse adsorption method) is 0 to 20%.

3. The fuel cell according to claim 1,
wherein a content ratio of the electrolyte in the anode catalyst layer is over 40% by weight and not greater than 80% by weight.

4. The fuel cell according to claim 1,
wherein the anode catalyst layer contains a reinforcing material.

5. The fuel cell according to claim 4,
wherein the reinforcing material is at least one kind selected from a fibrous substance, a granular substance, and a porous support.
